(19) United States
(12) Patent Application Publication
(10) Pub. No.: US 2022/0067307 A1
(43) Pub. Date: Mar. 3, 2022

(54) SYSTEM AND METHOD FOR TRAINING MULTILINGUAL MACHINE TRANSLATION EVALUATION MODELS

(71) Applicant: Unbabel Inc., San Francisco, CA (US)

(72) Inventors: Ricardo Rei, Oeiras (PT); Craig Stewart, Pittsburgh, PA (US); Ana Catarina Farinha, Lisbia Arroios (PT); Alon Lavie, Pittsburgh, PA (US)

(21) Appl. No.: 17/382,241

(22) Filed: Jul. 21, 2021

Related U.S. Application Data
(60) Provisional application No. 63/055,272, filed on Jul. 22, 2020.

(51) Int. Cl. G06F 40/51; G06F 40/284; G06F 40/58; G06N 3/08

(52) U.S. Cl. CPC G06F 40/51; G06N 3/084; G06F 40/58; G06F 40/284

(57) ABSTRACT

A system for training multilingual machine translation evaluation models and methods for making and using the same. The system can utilize a multilingual embedding space to leverage information from system inputs, including original source language, at least one machine translation of the original source language and at least one reference translation. The system can improve the accuracy of translation quality predictions by assigning a translation quality score based on the system inputs to be assigned to the machine translation. The translation quality score advantageously can demonstrate value added by using the original source language as an input to machine translation evaluation models.

### CROSS-REFERENCE TO RELATED APPLICATIONS

This application claims the benefit of, and priority to, U.S. Provisional Application Ser. No. 63/055,272, filed Jul. 22, 2020, the disclosure of which is hereby incorporated herein by reference in its entirety and for all purposes.

### FIELD

The disclosed embodiments relate generally to data processing systems and more particularly, but not exclusively, to data processing systems and methods suitable for training and utilizing multilingual neural network systems that are designed to evaluate the quality of translations generated by machine translation systems, sometimes referenced herein as multilingual machine translation evaluation models.

### BACKGROUND

Historically, metrics for evaluating the quality of machine translation (or MT) have relied on assessing the similarity between a MT-generated translation hypothesis and a human-generated reference translation in the target language. Traditional metrics have largely focused on basic, lexical-level features such as counting the number of matching words and sequences of words (or n-grams) between the MT hypothesis and the reference translation. Metrics such as Bilingual Evaluation Understudy (or BLEU), as described in “BLEU: a Method for Automatic Evaluation of Machine Translation,” by Kishore Papineni et al., 2002, and METEOR, as described in “The METEOR metric for automatic evaluation of machine translation,” by Alon Lavie et al., 2009, remain popular as a means of evaluating MT systems due to their light-weight and fast computation.

Modern neural approaches to MT result in much higher quality of translation than earlier technology, which often deviates from monotonic lexical transfer between languages and is much more expressive than can be captured and reflected in a single reference translation. For this reason, it has become increasingly evident that metrics such as BLEU are no longer able to provide an accurate estimate of the quality of current state-of-the-art MT systems.

While an increased research interest in neural methods for training MT models and systems has resulted in a recent, dramatic improvement in MT quality, MT evaluation has lagged behind. The MT research community still largely relies on outdated metrics and no new, widely-adopted standard has emerged. For example, in 2019, the WMT News Translation Shared Task, a recognized annual benchmark evaluation of MT technology, received a total of 153 MT system submissions as described in “Findings of the 2019 Conference on Machine Translation (WMT19),” by Loïc Barrault et al., 2019. The Metrics Shared Task of the same year, a track for benchmarking MT evaluation metrics, saw only twenty-four submissions, almost half of which were entrants to the Quality Estimation Shared Task, adapted to serve as metrics as described in “Results of the WMT19 Metrics Shared Task: Segment-Level and Strong MT Systems Pose Big Challenges,” by Qingsong Ma et al., 2019.

The findings of the above-mentioned task highlighted two major challenges that prior existing MT evaluation metrics have been largely unable to address. Namely, that current metrics struggle to accurately correlate with human quality scores at the segment level and fail to correctly rank the highest performing MT systems.

Classic MT evaluation metrics are commonly characterized as n-gram matching metrics because, using hand-crafted features, they estimate MT quality by counting the number and fraction of n-grams that appear simultaneously in a candidate translation hypothesis and one or more human-reference translations. Metrics such as BLEU, METEOR, and chrF as described in “CHRF: character n-gram F-Score for automatic MT evaluation,” by Maja Popović, 2015, have been widely studied and improved (“Moses: Open Source Toolkit for Statistical Machine Translation,” Philipp Koehn et al., 2007; “CHRF⁺⁺: words helping character n-grams,” by Maja Popović, 2017; “Meteor 1.3: Automatic Metric for Reliable Optimization and Evaluation of Machine Translation Systems,” Michael Denkowski et al., 2011; “Meteor++ 2.0: Adopt Syntactic Level Paraphrase Knowledge into Machine Translation Evaluation,” by Yinuo Guo et al., 2019), but, due to their lexical nature, they usually fail to recognize and capture semantic similarity and translation nuances beyond the lexical level.

In recent years, word embeddings (“Distributed Representations of Words and Phrases and their Compositionality,” Tomas Mikolov et al., 2013; “GloVe: Global Vectors for Word Representation,” Jeffrey Pennington et al., 2014; “Deep contextualized word representations,” Matthew E. Peters et al., 2018; “BERT: Pre-training of Deep Bidirectional Transformers for Language Understanding,” Jacob Devlin et al., 2019) have emerged as a commonly used alternative to n-gram matching for capturing word and segment-level semantic similarity. More recent embedding-based metrics like YiSi-1 (“YiSi—A Unified Semantic MT Quality Evaluation and Estimation Metric for Languages with Different Levels of Available Resources,” Chi-kiu Lo, 2019), MoverScore (“MoverScore: Text Generation Evaluating with Contextualized Embeddings and Earth Mover Distance,” Wei Zhao et al., 2019) and BERTScore (“BERTScore: Evaluating Text Generation with BERT,” Tianyi Zhang et al., 2020) create soft-alignments between reference and hypothesis in an embedding space and then compute a score that reflects the semantic similarity between those segments. However, human quality scores such as Direct Assessment (or DA) (“Continuous Measurement Scales in Human Evaluation of Machine Translation,” Yvette Graham et al., 2013) and Multidimensional Quality Metrics (or MQM) (“Multidimensional Quality Metrics (MQM): A Framework for Declaring and Describing Translation Quality Metrics,” Arle Lommel et al., 2014), capture much more than just semantic similarity, thus limiting the ability of the scores generated by such metrics to correlate well with these forms of human quality scores.

Learnable metrics (“RUSE: Regressor Using Sentence Embeddings for Automatic Machine Translation Evaluation,” Hiroki Shimanaka et al., 2018; “Putting Evaluation in Context: Contextual Embeddings Improve Machine Translation Evaluation,” Mitika Mathur et al., 2019) attempt to learn parameters that directly optimize the correlation with human quality scores, and have recently shown promising results. BLEURT (“BLEURT: Learning Robust Metrics for Text Generation,” Thibault Sellam et al., 2020), a recent learnable metric based on BERT (“BERT: Pre-training of Deep Bidirectional Transformers for Language Understanding,” Jacob Devlin et al., 2019), has exhibited state-of-the-art performance on data from the last three years of the WMT Metrics Shared task. Furthermore, all previously proposed learnable metrics have focused on optimizing their parameters to Direct Assessment (DA) data which, due to a scarcity of annotators, can be inherently noisy as described in “Results of the WMT19 Metrics Shared Task: Segment-Level and Strong MT Systems Pose Big Challenges,” by Qingsong Ma et al., 2019.

Reference-less MT evaluation, also known as Quality Estimation (or QE), has historically been trained and evaluated on predicting Human-mediated Translation Edit Rate (or HTER) (“A Study of Translation Edit Rate with Targeted Human Annotation,” Snover et al., 2006) in segment-level evaluation settings (“Findings of the 2013 Workshop on Statistical Machine Translation,” Ondřej Bojar et al., 2013; “Findings of the 2014 Workshop on Statistical Machine Translation,” Ondřej Bojar et al., 2014; “Findings of the 2015 Workshop on Statistical Machine Translation,” Ondřej Bojar et al., 2015; “Findings of the 2016 Workshop on Statistical Machine Translation,” Ondřej Bojar et al., 2016; “Findings of the 2017 Workshop on Statistical Machine Translation,” Ondřej Bojar et al., 2017). More recently, MQM has been used for document-level evaluation (“Findings of the WMT 2018 Shared Task on Quality Estimation,” Lucia Specia et al., 2018; “Findings of the WMT 2019 Shared Task on Quality Estimation,” Erick Fonseca et al., 2019). Recent new QE systems, such as “Unbabel's Participation in the WMT19 Translation Quality Estimation Shared Task,” Fabio Kepler et al., 2019, have exhibited dramatically improved correlations with human quality scores by leveraging highly multilingual pretrained encoders such as multilingual BERT (“BERT: Pre-training of Deep Bidirectional Transformers for Language Understanding,” Jacob Devlin et al., 2019) and cross-lingual language models such as XLM (“Cross-lingual Language Model Pretraining,” Alexis Conneau et al., 2019). Concurrently, the OpenKiwi framework (“OpenKiwi: An Open Source Framework for Quality Estimation,” Fabio Kepler et al., 2019) has made it easier for researchers to push the field forward and build stronger QE models.

In view of the foregoing, a need exists for an improved system and method for training multilingual machine translation evaluation models that overcomes the aforementioned obstacles and deficiencies of currently-available methods for evaluating the quality of machine translation.

### BRIEF DESCRIPTION OF THE DRAWINGS

FIG. 1 is a top-level block diagram illustrating an exemplary embodiment of an evaluation model training system for training multilingual machine translation evaluation models.

FIGS. 2A-C are top-level data flow diagrams illustrating an exemplary embedding, combining and outputting operations of the evaluation model training system of FIG. 1.

FIG. 3A is a top-level block diagram illustrating an alternative exemplary embodiment of the evaluation model training system of FIG. 1, wherein the evaluation model training system implements a first model training objective of regressing directly on a machine translation quality score.

FIG. 3B is a top-level block diagram illustrating another alternative exemplary embodiment of the evaluation model training system of FIG. 1, wherein the evaluation model training system implements a second model training objective of “triplet margin loss” minimization, whereas the embedding representations learnt by the model during training are modified so as to move the embeddings of an original source language segment and a reference translation to be closer to those of a better machine translation of the original source language and/or further away from a worse machine translation of the original source language.

FIG. 4 is a top-level block diagram illustrating yet another alternative exemplary embodiment of the evaluation model training system of FIG. 1, wherein the evaluation model training system receives multiple reference translations.

FIGS. 5A-C illustrate performance assessments for exemplary machine translation evaluation metrics/models evaluated on top-performing MT systems.

FIG. 6 is a top-level flow chart illustrating an exemplary embodiment of an evaluation model training method for the evaluation model training system of FIG. 1.

FIG. 7A is a top-level flow chart illustrating an exemplary embodiment of a method for training an estimator-based multilingual machine translation evaluation model for the evaluation model training system of FIG. 1.

FIG. 7B is a top-level flow chart illustrating an exemplary embodiment of a method for training a translation ranking-based multilingual machine translation evaluation model for the evaluation model training system of FIG. 1.

It should be noted that the figures are not drawn to scale and that elements of similar structures or functions may be generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

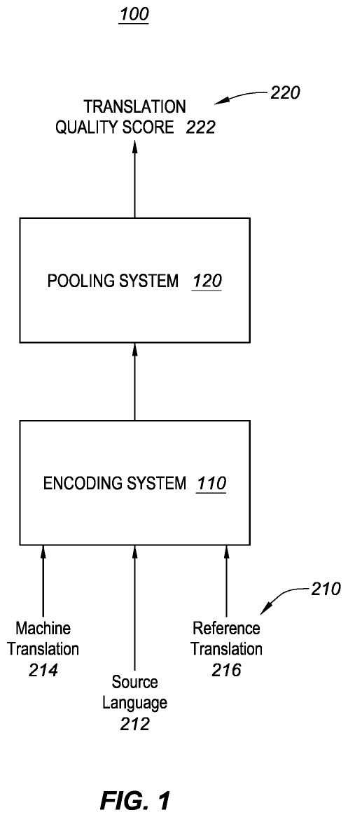

Since currently-available methods for evaluating machine translation (MT) quality rely on outdated metrics, lack any widely-adopted standard, struggle to accurately correlate with human quality scores and fail to correctly rank highest performing MT systems, a system and method for training multilingual machine translation evaluation models that can use cross-lingual language modeling and a predictive neural network to generate prediction estimates of human quality scores can prove desirable and provide a basis for a wide range of system applications, such as generation of a statistically-informed prediction of machine translation quality based on one or more examples of prior human action and/or generation of a score for a new machine translation based upon scores assigned by humans to previous translations. This result can be achieved, according to selected embodiments disclosed herein, by an evaluation model training system 100 for training multilingual machine translation evaluation models as illustrated in FIG. 1.

In selected embodiments, the evaluation model training system 100 can comprise a framework for training highly multilingual and adaptable machine translation (or MT) evaluation models (not shown) that can function as metrics. The framework, for example, can be implemented using the PyTorch neural software library (“PyTorch: An Imperative Style, High-Performance Deep Learning Library”, by Adam Paszke et al. 2019), primarily developed by Facebook's AI Research Lab. Turning to FIG. 1, the evaluation model training system 100 is shown as including an encoding system 110 that is in communication with a pooling system 120. The encoding system 110 is configured to receive selected system input 210. As shown in FIG. 1, the selected system input 210 can include an original source language input text segment 212, a predetermined number of machine translations (or hypotheses) 214 of the original source language input text segment 212 and at least one reference translation 216.

In selected embodiments, the evaluation model training system 100 can be configured to receive any suitable number of machine translations 214 of the original source language input text segment 212. Exemplary numbers of machine translations 214 can include one or two machine translations 214, without limitation. The original source language input text segment 212, for example, can comprise a source-language input word, a source-language input sentence and/or a source-language input segment, comprising a plurality of source-language input words or sentences. At least one feature based on the original source language input text segment 212 can be incorporated into the machine translation evaluation models.

In selected embodiments, the encoding system 110 can comprise one or more transformer encoder layers (not shown). An exemplary building block of the MT evaluation models can be a pretrained, cross-lingual encoder model. Exemplary pretrained, cross-lingual encoder models can include multilingual BERT (“BERT: Pre-training of Deep Bidirectional Transformers for Language Understanding,” Jacob Devlin et al., 2019), and cross-lingual language models such as XLM (“Cross-lingual Language Model Pretraining,” Alexis Conneau et al., 2019) and/or XLM-RoBERTa (“Unsupervised Cross-lingual Representation Learning at Scale”, Alexis Conneau et al., 2020), without limitation. The pretrained, cross-lingual model can include at least one of the transformer encoder layers. When trained with large amounts of data from multiple languages, these pretrained, cross-lingual models can be highly effective in serving as an encoder model for providing a basis to train other neural models that perform various cross-lingual tasks such as document classification and natural language inference and can generalize well to unseen languages and scripts.

The example analysis presented herein relies on XLM-RoBERTa (base), as described in “Unsupervised Cross-lingual Representation Learning at Scale”, Alexis Conneau et al., 2020, as the encoder model. Given an input sequence x=[x₀, x₁, . . . , xₙ], the encoder system 110 can produce an embedding eⱼ^{(l)} for each token xⱼ and each layer l∈{0, 1, . . . , k}. The embedding process can be applied to the original source language input text segment 212, the machine translation 214 and/or the reference translation 216 to map the original source language input text segment 212, the machine translation 214 and/or the reference translation 216 into a shared embedding feature space. The embeddings generated by the last, or any other, layer of the pretrained encoders of the encoder system 110 can be used for fine-tuning the model parameters to support one or more new tasks, including the prediction of MT evaluation scores.

Advantageously, different transformer encoder layers of the encoder system 110 can capture linguistic information that can be relevant for one or more different downstream tasks. In the case of MT evaluation, the different transformer encoder layers can encode different aspects of meaning representation that can be useful as input features for predicting the quality of an MT hypothesis, generalizing and improving upon the utility of leveraging only the last transformer encoder layer. In selected embodiments, the pooling layer can pool information from the most important transformer encoder layers into a single embedding for each token, e₁, by using a layer-wise attention mechanism. The resultant embedding can be computed as:

eₓ_{ⱼ}=μEₓ_{ⱼ}^{T}α (Equation 1)

where μ is a trainable weight coefficient, Eⱼ=[eⱼ⁽⁰⁾, eⱼ⁽¹⁾, . . . , eⱼ^{(k)}] corresponds to a vector of transformer encoder layer embeddings for token xⱼ, and α=softmax([α⁽¹⁾, α⁽²⁾, . . . , α^{(k)}]) is a vector corresponding to layer-wise trainable weights. To avoid overfitting to the information contained in any single transformer encoder layer, the pooling system 120 can use layer dropout whereas with a probability p the weight α⁽ⁱ⁾ is set to −∞.

In selected embodiments, the pooling system 120 can apply average pooling to the resulting word embeddings to derive a sentence and/or segment embedding for each of the inputs: the source-language input 212, the machine translation hypothesis 214, the reference translation 216 and/or other system inputs 210. The pooling system 120 thereby can leverage features extracted from these sentence and/or segment embedded inputs to evaluate the machine translation 214, and provide one or more system outputs 220, such as a machine translation quality score 222, for setting forth at least one evaluation result for the machine translation 214 of the original source language input text segment 212.

The evaluation model training system 100 can utilize a multilingual embedding space to leverage information from the system inputs 210, including the original source language input text segment 212, the machine translation 214 of the original source language input text segment 212 and the reference translation 216. Thereby, the evaluation model training system 100 can improve an accuracy of translation quality predictions by assigning the machine translation quality score 222 based on the system inputs 210 to be assigned to the machine translation 214. The machine translation quality score 222 advantageously can demonstrate value added by using the original source language input text segment 212 as an input to machine translation evaluation models.

In selected embodiments, the evaluation model training system 100 advantageously can utilize cross-lingual language modeling and/or a predictive neural network to generate prediction estimates of various human quality scores. Exemplary predictions estimates can include, but are not limited to, Direct Assessments (or DA), Multidimensional Quality Metric (or MQM) and/or Human-mediated Translation Edit Rate (or HTER). Direct Assessments optionally can be converted into pairs of relative rankings from the Direct Assessments (or DARR), for example, when a number of annotations per segment of the original source language input text segment 212 is limited. Stated somewhat differently, for two machine translations 214 of a selected source-language input segment of the original source language input text segment 212, the Direct Assessment score associated with the first machine translation 214 of the selected source-language input segment can be higher than the Direct Assessment score associated with the second machine translation 214 of the selected source-language input segment such that the first machine translation 214 can be regarded as being a better translation than the second machine translation 214. Additionally and/or alternatively, if a difference between the first and second Direct Assessments scores is not higher than twenty-five points, the selected source-language input segment can be excluded from the DARR data.

The evaluation model training system 100 advantageously can evaluate the original source language input text segment 212, the machine translation 214, the reference translation 216 and/or other system inputs 210 and generate the machine translation quality score 222 and/or other system outputs 220 in an effective and/or flexible manner. In selected embodiments, the evaluation model training system 100 can train two or more exemplary machine translation evaluation models for estimating different types of human quality scores. For example, the evaluation model training system 100 can support two or more distinct system architectures to train the exemplary machine translation evaluation models for estimating different types of human quality scores.

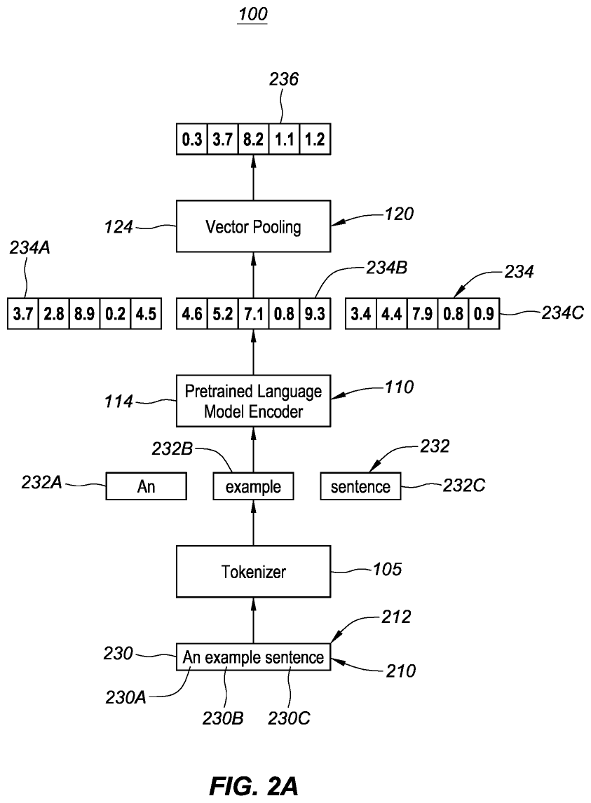

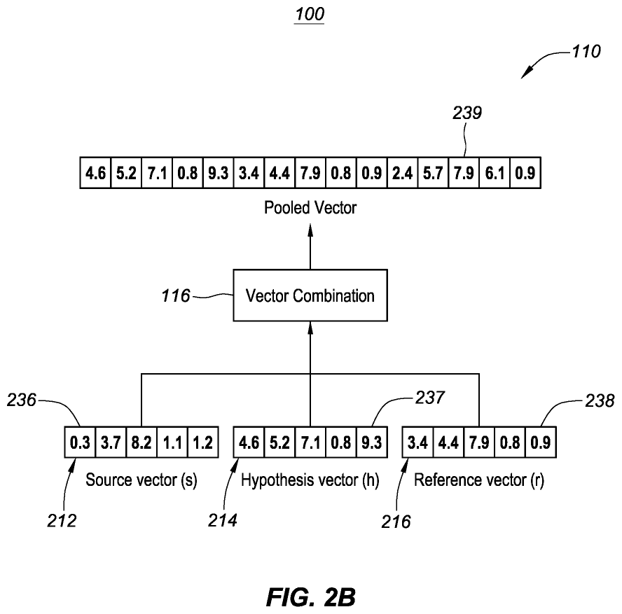

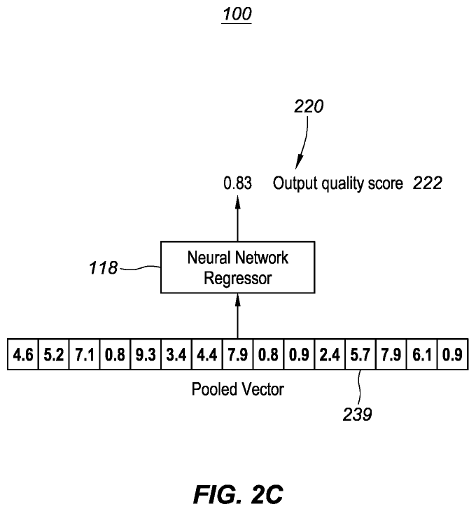

Exemplary embedding, combining and outputting operations of the evaluation model training system 100 are illustrated in FIGS. 2A-C. Turning to FIG. 2A, the evaluation model training system 100 can receive an example sentence or segment 230 as the source-language input 212. The example sentence or segment 230 can comprise a predetermined number of words 230A-C, phrases and/or clauses, etc. For purposes of illustration only, the example sentence 230 is shown as including three words 230A-C.

The evaluation model training system 100 of FIG. 2A can include a tokenizer system 105 for receiving the example sentence 230 and separating the example sentence 230 into one or more tokens 232. The tokenizer system 105, for example, can separate the three words 230A-C into three respective tokens 232A-C. Stated somewhat differently, a first word 230A of the example sentence 230 can be separated into a first token 232A, a second word 230B of the example sentence 230 can be separated into a second token 232B and/or a third word 230C of the example sentence 230 can be separated into a third token 232C as shown in FIG. 2A.

The tokenizer system 105 can provide the tokens 232A-C to a pretrained language model encoder system 114 of the evaluation model training system 100. The pretrained language model encoder system 114 can receive the tokens 232A-C and, based at least in part upon the tokens 232A-C, generate at least one token embedding 234. As illustrated in FIG. 2A, for example, the pretrained language model encoder system 114 can receive the three tokens 232A-C and generate three respective token embeddings 234A-C. In selected embodiments, the pretrained language model encoder system 114 can generate a token embedding 234 for each token 232.

The evaluation model training system 100 can further include a vector pooling system 124 for receiving the token embeddings 234 and pooling the received token embeddings 234 into at least one source vector 236. FIG. 2A shows that the vector pooling system 124 can pool the received token embeddings 234 into one source vector 236. The example sentence 230 thereby can be embedded into the source vector 236. Stated somewhat differently, the source vector 236 can be generated based upon the example sentence 230 and, thus, the source-language input 212.

Turning to FIG. 2B, the source vector 236 can be provided to a vector combination system 116. The vector combination system 116 advantageously can combine the source vector 236 with one or more other vectors, such as a hypothesis vector 237 and/or a reference vector 238, to form a pooled vector 239 as illustrated in FIG. 2B. The hypothesis vector 237 can be generated based upon the machine translation hypothesis 214 and/or the reference vector 238 can be generated based upon the reference translation 216. In selected embodiments, the machine translation hypothesis 214 can be embedded into the hypothesis vector 237 in the manner by which the example sentence 230 is embedded into the source vector 236 as discussed in more detail above with reference to FIG. 2A. Additionally and/or alternatively, the reference translation 216 can be embedded into the reference vector 238 in the manner discussed above with reference to FIG. 2A.

The vector combination system 116 can provide the pooled vector 239 to a neural network regressor system 118 as shown in FIG. 2C. The neural network regressor system 118 can receive the pooled vector 239 and provide at least one of system outputs 220, such as the machine translation quality score 222. The machine translation quality score 222 can be provided in the manner discussed in more detail above with reference to FIG. 1 and advantageously can set forth at least one evaluation result for the machine translation 214 of the original source language input text segment 212.

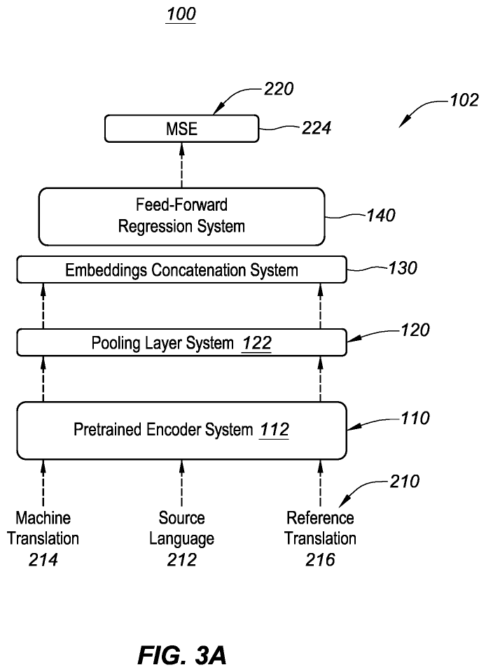

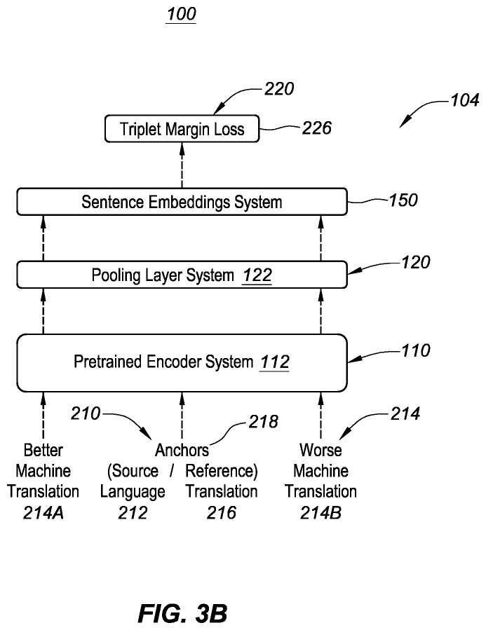

A first exemplary system architecture, sometimes referenced herein as being an estimator model architecture, of the evaluation model training system 100 is shown in FIG. 3A. Turning to FIG. 3A, the estimator model training system 102 is illustrated as including the encoding system 110 and the pooling system 120 for generating the predicted machine translation quality score 222 in the manner described in more detail above with reference to the evaluation model training system 100 of FIG. 1. The encoding system 110, for example, can comprise a pretrained and/or cross-lingual encoder system 112; whereas, the pooling system 120 can comprise a layered pooling system 122 with one or more transformer encoder layers. The estimator model training system 102 advantageously can be configured to implement a first model training objective of regressing directly on the machine translation quality score 222.

In selected embodiments, the original source language input text segment 212, the machine translation 214 and the reference translation 216 can be independently encoded via the pretrained and/or cross-lingual encoder system 112. The resulting word embeddings can be passed through the layered pooling system 122 to an embeddings concatenation system 130. The embeddings concatenation system 130 can create a sentence embedding for each segment. Additionally and/or alternatively, the embeddings concatenation system 130 can combine and concatenate the resulting sentence embeddings into a single vector that is passed to a feed-forward neural network that can serve as a regressor system 140. The entire multilingual machine translation evaluation model thereby can be trained on the collection of available training examples for all language pairs by minimizing a Mean Squared Error (MSE) value 224 between the scores predicted by the model and the human-generated scores associated with the training examples.

For example, the pooling system 120 can provide a d-dimensional sentence embedding for the original source language input text segment 212, the machine translation (or hypothesis) 214 of the original source language input text segment 212 and the reference translation 216 to the embeddings concatenation system 130. The embeddings concatenation system 130 can calculate and/or extract multiple features from these embeddings, including but not limited to, an element-wise product between the embeddings of the machine translation (or hypothesis) 214 and the embedding for the original source language input text segment 212, an element-wise product between the embeddings of the machine translation (or hypothesis) 214 and the embedding for the reference translation 216, an absolute element-wise difference between the hypothesis 214 and the source 212, and/or an absolute element-wise difference between the hypothesis 214 and the reference 216, in accordance with Equations 2-5.

Element-wise source product: h⊙s (Equation 2)

Element-wise reference product: h⊙r (Equation 3)

Absolute element-wise source difference: |h−s| (Equation 4)

Absolute element-wise reference difference: |h−r| (Equation 5)

wherein h represents a hypothesis embedding of the machine translation (or hypothesis) 214, s represents a source embedding of the original source language input text segment 212 and r represents a reference embedding of the reference translation 216.

The embeddings concatenation system 130 can concatenate the element-wise source product h⊙s of Equation 2, the element-wise reference product h⊙r of Equation 3, the absolute element-wise source difference |h−s| of Equation 4 and/or the absolute element-wise reference difference |h−r| of Equation 5 to the reference embedding r and/or the hypothesis embedding h into a single vector x=[h; r; h⊙s; h⊙r; |h−s|; |h−r|], which can be provided as an input to the feed-forward regression system 140. By augmenting the d-dimensional embeddings of the MT hypothesis h and the reference r, the element-wise source product h⊙s, the element-wise reference product h⊙r, the absolute element-wise source difference |h−s| and/or the absolute element-wise reference difference |h−r| advantageously can help to highlight any differences between these embeddings in a semantic feature space.

While cross-lingual pretrained models are trained to cover multiple languages, the feature space between the languages is not well aligned. Accordingly, although the element-wise source product h⊙s and the absolute element-wise difference |h−s| can be useful features for the embeddings concatenation system 130, the raw source embedding s may be omitted as input to the embeddings concatenation system 130 in selected embodiments.

The multilingual machine translation evaluation model is then trained on a collection of MT evaluation training examples to minimize the mean squared error 224 between the predicted scores and human-generated quality scores, such as Direct Assessments, Multidimensional Quality Metric and/or Human-mediated Translation Edit Rate.

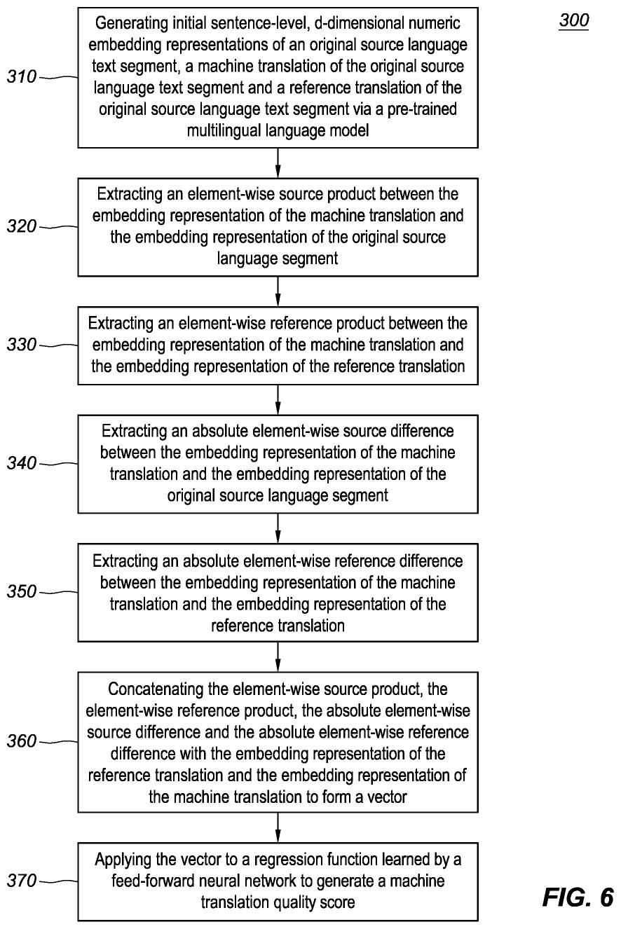

An exemplary evaluation model training method 300 for the evaluation model training system 100 is illustrated in FIG. 6. In selected embodiments, the evaluation model training method 300 can comprise an estimator model architecture-based method for training a multilingual machine translation evaluation model. Turning to FIG. 6, the evaluation model training method 300 can include, at 310, generating initial sentence-level, d-dimensional numeric embedding representations of the original source language input text segment 212 (shown in FIG. 1), the machine translation 214 (shown in FIG. 1) of the original source language text segment 212 and the reference translation 216 (shown in FIG. 1) of the original source language text segment 212 via a pre-trained multilingual language model (not shown).

The evaluation model training method 300 can include extracting an element-wise source product between the embedding representation of the machine translation 214 and the embedding representation of the original source language segment 212, at 320. In selected embodiments, the element-wise source product, at 320, can be generated in the manner discussed in more detail above with reference to Equation 2. At 330, the evaluation model training method 300 can include extracting an element-wise reference product between the embedding representation of the machine translation 214 and the embedding representation of the reference translation 216. The element-wise reference product, at 330, can be generated in the manner discussed in more detail above with reference to Equation 3.

At 340, an absolute element-wise source difference between the embedding representation of the machine translation 214 and the embedding representation of the original source language segment 212 can be extracted. The absolute element-wise source difference, at 340, can be generated in the manner discussed in more detail above with reference to Equation 4. An absolute element-wise reference difference between the embedding representation of the machine translation 214 and the embedding representation of the reference translation 216 can be extracted, at 350. The absolute element-wise reference difference, at 350, can be generated in the manner discussed in more detail above with reference to Equation 5.

As shown in FIG. 6, the evaluation model training method 300 can include, at 360, concatenating the element-wise source product, the element-wise reference product, the absolute element-wise source difference and the absolute element-wise reference difference with the embedding representation of the reference translation 216 and the embedding representation of the machine translation 214 to form a vector. The vector can be applied, at 370, to a regression function learned by a feed-forward neural network to generate the machine translation quality score 220. Stated somewhat differently, the vector can be passed through a feed-forward neural network (not shown) that is designed to learn a regression function that generates and outputs the machine translation quality score 220 as a scalar numeric score.

Additionally and/or alternatively, the evaluation model training system 100 can be provided with a second exemplary system architecture, sometimes referenced herein as being a translation ranking model architecture, as illustrated in FIG. 3B. The translation ranking model training system 104 can be provided in the manner set forth in more detail above with reference to the evaluation model training system 100 of FIG. 1 and include the encoding system 110 and the pooling system 120 for providing the machine translation quality score 222. The encoding system 110, for example, can comprise the pretrained and/or cross-lingual encoder system 112; whereas, the pooling system 120 can comprise a layered pooling system 122 with one or more transformer encoder layers in the manner described above with reference to the pretrained encoder system 112 and the layered pooling system 122 of FIG. 3A.

Turning to FIG. 3B, the translation ranking model training system 104 advantageously can be configured to implement a second “triplet margin loss” model training objective that aims to fine-tune the embedding representations so as to reduce the distance between the embeddings of the original source language input text segment 212 and the reference translation 216 and a better machine translation 214A of the original source language input text segment 212 while increasing the distance between the embeddings of the original source language input text segment 212 and the reference translation 216 and a worse machine translation 214B of the original source language input text segment 212. Stated somewhat differently, the second model training objective can include minimizing a first distance between the original source language input text segment 212 and the reference translation 216 (collectively, translation anchors 218) and the better machine translation 214A and/or maximizing a second distance between the translation anchors 218 and the worse machine translation 214B. The translation ranking model training system 104 thereby can “pull” the better machine translation 214A toward the translation anchors 218 and/or can “push” the worse machine translation 214B away from the translation anchors 218.

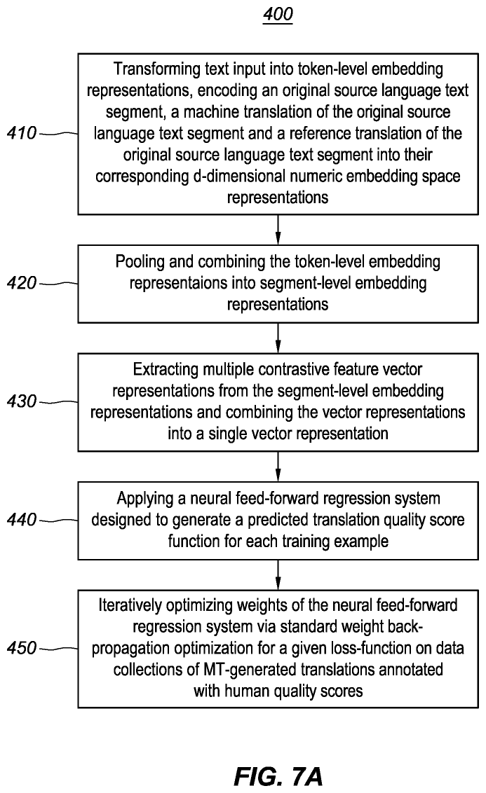

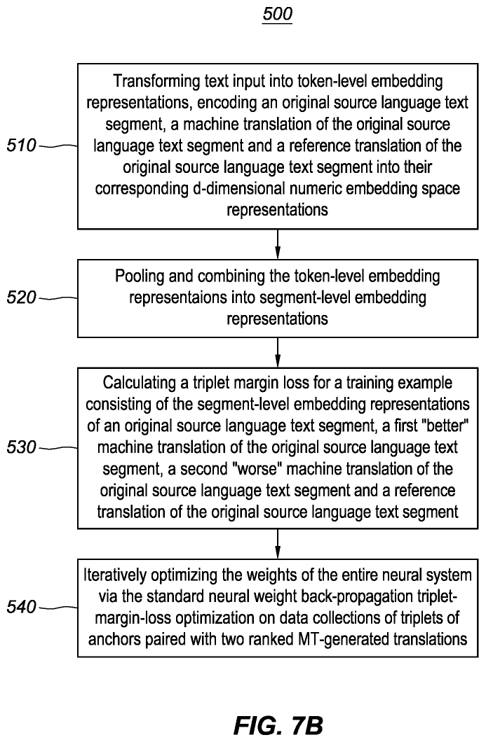

Alternative exemplary evaluation model training methods 400, 500 for the evaluation model training system 100 are illustrated in FIGS. 7A-B, respectively. Turning to FIG. 7A, for example, the evaluation model training method 400 can involve training an estimator-based multilingual machine translation evaluation model by iteratively optimizing weights of the entire neural system, including the encoder system, the layer attention mechanism and/or the feed-forward regression system, via standard neural back-propagation optimization on data collections of MT-generated translations annotated with human quality scores. The method 400 can include, at 410, transforming text input into token-level embedding representations. An original source language text segment 212, a machine translation 214 of the original source language text segment 212 and a reference translation 216 of the original source language text segment 212 can be encoded into their corresponding d-dimensional numeric embedding space representations.

At 420, the method 400 can include pooling and combining the token-level embedding representations into segment-level embedding representations. Multiple contrastive feature vector representations from the segment-level embedding representations can be extracted and the vector representations can be combined into a single vector representation, at 430. The method of FIG. 7A is shown as including, at 440, applying a neural feed-forward regression system designed to generate a predicted translation quality score for each training example. At 450, the method 400 can iteratively optimize the weights of the entire neural system, including the encoder system, the layer attention mechanism and/or the feed-forward regression system via standard neural weight back-propagation optimization for a given loss-function on data collections of MT-generated translations annotated with human quality scores.

The evaluation model training method 500, alternatively, can involve training a translation ranking-based multilingual machine translation evaluation model by iteratively optimizing weights of the entire neural system, including the encoder system and/or the layer attention mechanism, via standard neural back-propagation triplet-margin-loss optimization on data collections of triplets of anchors (a source segment and a reference translation of the source segment) paired with two ranked MT-generated translations (a “better” MT hypothesis and a “worse” MT hypothesis). Turning to FIG. 7B, the method 500 is shown as including, at 510, transforming text input into token-level embedding representations. An original source language text segment 212, a machine translation 214 of the original source language text segment 212 and a reference translation 216 of the original source language text segment 212 into their corresponding d-dimensional numeric embedding space representations.

The token-level embedding representations can be pooled and combined, at 520, into segment-level embedding representations. At 530, the method 500 can calculate a triplet margin loss for a training example consisting of the segment-level embedding representations of an original source language text segment 212, a first “better” machine translation 214A of the original source language text segment 212, a second “worse” machine translation 214B of the original source language text segment 212 and a reference translation 216 of the original source language text segment 212. The weights of the entire neural system, including the encoder system and/or the layer attention mechanism, can be iteratively optimized, at 540, via the standard neural weight back-propagation triplet-margin-loss optimization on data collections of triplets of anchors (a source segment and a reference translation of the source segment) paired with two ranked MT-generated translations (a “better” MT hypothesis and a “worse” MT hypothesis).

In operation, the system 100 can receive the original source language input text segment 212, the better machine translation 214A, the worse machine translation 214B and the reference translation 216. The original source language input text segment 212, better machine translation 214A, the worse machine translation 214B and the reference translation 216 can be independently encoded using the pretrained encoder system 112 and the layered pooling system 122. Using a triplet margin loss the resulting embedding space can be optimized to minimize or otherwise reduce a distance between the better machine translation 214A and the translation anchors 218.

For example, the translation ranking model training system 104 can receive a tuple χ=(s, h⁺, h⁻, r), wherein s represents a source embedding of the original source language input text segment 212, h⁺ represents the better machine translation 214A and that has been ranked higher than the worse machine translation 214B, h⁻ represents the worse machine translation 214B and r represents a reference embedding of the reference translation 216. The tuple χ can be passed through the encoding system 110 and the pooling system 120 and provided to a sentence embeddings system 150. The sentence embeddings system 150 can generate a sentence embedding for each segment in the tuple x. For example, the sentence embeddings system 150 can utilize one or more embeddings {s, h⁺, h⁻, r} to calculate a triplet margin loss 226 in relation to the source embedding s and the reference embedding r can be computed in accordance with Equations 6-8:

L(χ)=L(s,h⁺,h⁻)+L(r,h⁺,h⁻) (Equation 6)

wherein:

L(s,h⁺,h⁻)=max{0,d(s,h⁺)−d(s,h⁻)+ε} (Equation 7)

L(r,h⁺,h⁻)=max{0,d(r,h⁺)−d(r,h⁻)+ε} (Equation 8)

wherein d(u, v) denotes a Euclidean distance function between u and v and ∈ is a margin. Thus, during training, the multilingual machine translation evaluation model can optimize the embedding space so that the distance between the translation anchors 218 and the worse machine translation 214B is greater by at least ∈ than the distance between the translation anchors 218 and the better machine translation 214A.

During inference, the described multilingual machine translation evaluation model can receive a triplet (s, ĥ, r) that includes a single MT hypothesis ĥ. The single MT hypothesis ĥ, in selected embodiments, can refer to a translation produced by an independent MT system (not shown) that is being evaluated. Stated somewhat differently, the hypothesis ĥ can be a hypothesis translation presented for evaluation to the MT evaluation model that was trained by the evaluation model training system.

The translation quality score 222 (shown in FIG. 1) can be assigned to the hypothesis ĥ and can comprise a harmonic mean between a first distance d(s, ĥ) from the hypothesis ĥ to the source embedding s and a second distance d(r, ĥ) from the hypothesis ĥ to the reference embedding r as set forth in Equation 9:

$$f ( s , \hat{h} , r ) = \frac{2 \times d ( r , \hat{h} ) \times d ( s , \hat{h} )}{d ( r , \hat{h} ) + d ( s , \hat{h} )} \qquad ( Equation 9 )$$

The harmonic mean between the first distance d(s, ĥ) and the second distance d(r, ĥ) can be converted into a similarity score bounded between 0 and 1 in accordance with Equation 10:

$$\hat{f} ( s , \hat{h} , r ) = \frac{1}{1 + f ( s , \hat{h} , r )} \qquad ( Equation 10 )$$

During standard training of the multilingual machine translation evaluation models, the evaluation model training system 100 can receive the selected system inputs 210. The evaluation model training system 100 preferably receives the selected system inputs 210 in the following order: the original source language input text segment 212 followed by any machine translations 214 and then followed by one or more reference translations 216. The evaluation model training system 100 thereby can concatenate the embeddings.

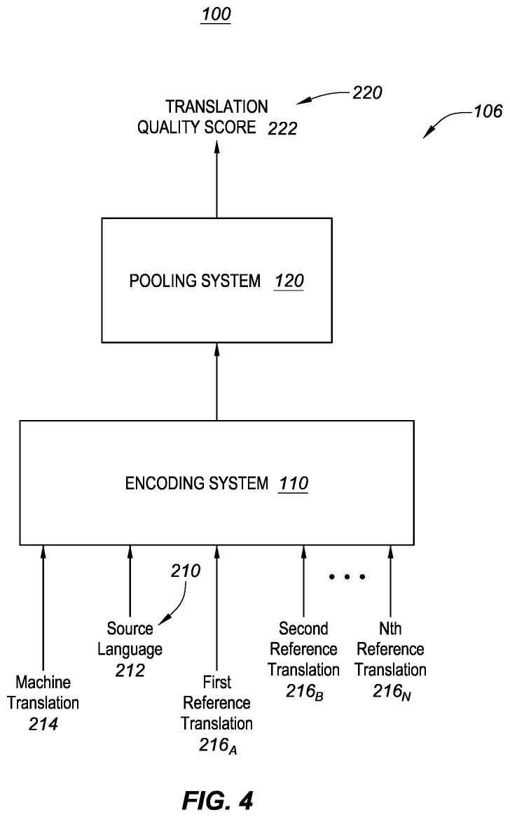

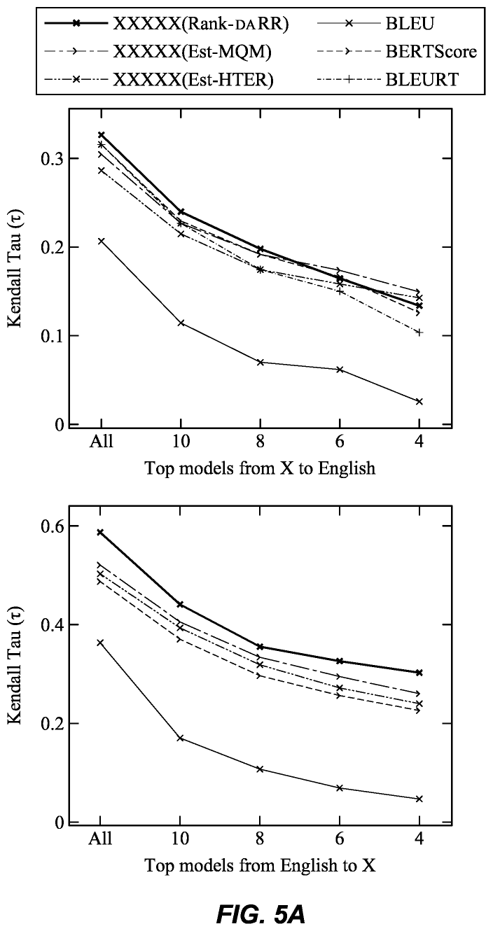

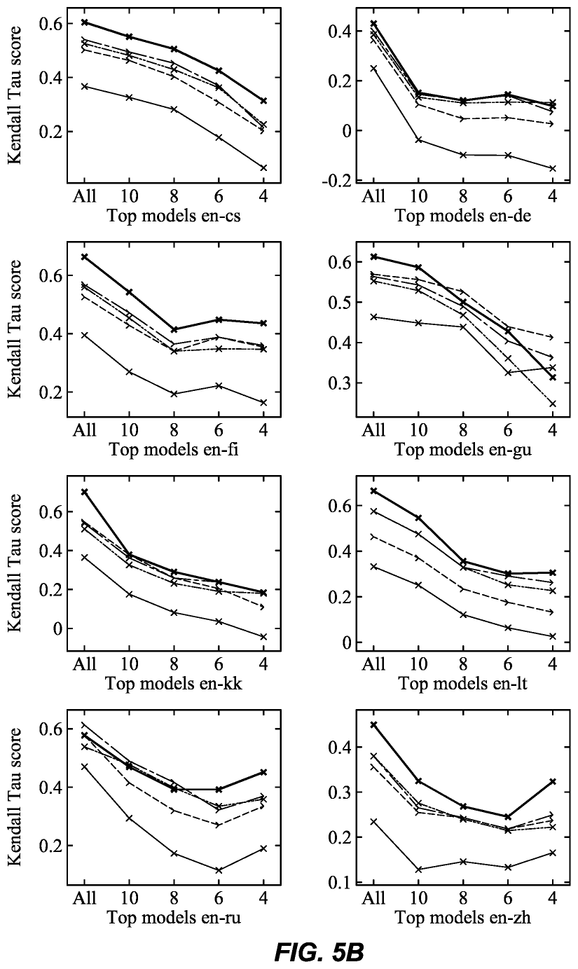

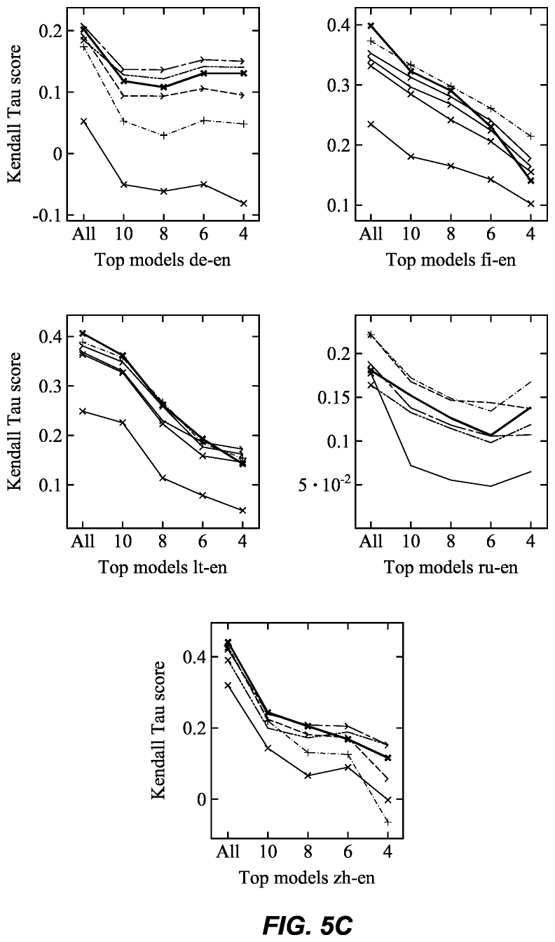

Another alternative embodiment of the evaluation model training system 100 is shown in FIG. 4. The system architecture of the evaluation model training system 100 is shown in FIG. 4 sometimes referenced herein as being a multi-reference model architecture. Turning to FIG. 4, the multi-reference model training system 106 can be provided in the manner set forth in more detail above with reference to the evaluation model training system 100 of FIGS. 1, 2A and/or 2B and include the encoding system 110 and the pooling system 120 for providing the machine translation quality score 222. The encoding system 110 of the multi-reference model training system 106 is configured to receive a predetermined number N of reference translations 216, wherein the predetermined number N can comprise any suitable integer that is greater than one. Stated somewhat differently, the encoding system 110 can receive multiple reference translations 216, including a first reference translation 216_{A}, a second reference translation 216_{B}, up to an Nth reference translation 216N as shown in FIG. 4.

The training method for the multi-reference architecture is modified in order to promote the learning of model parameters that perform well when presented at inference time with zero, one or more reference translations. In order to support the learning of such effective parameters, the positions of the original source language input text segment 212 and the reference translation 216 can be switched during training with probability of 0.5. Stated somewhat differently, the system 110 can receive any one of the reference translations 216 as the original source language input text segment 212 and the original source language input text segment 212 as the reference translation 216. The multi-reference model training system 106 thereby can receive the selected system inputs 210 in the following order: any of the one or more reference translations 216 followed by any machine translations 214 and then followed by the original source language input text segment 212. This order switching can be performed with a probability of 0.5 throughout the course of training the model.

By switching the positions of the original source language input text segment 212 and the reference translations 216, the source embeddings can be aligned with the target language embedding space during fine-tuning of the underlying multilingual machine translation evaluation model and can result in more useful source embeddings. Switching the positions of the original source language input text segment 212 and the reference translations 216 likewise can force the underlying multilingual machine translation evaluation model to treat the original source language input text segment 212 and the reference translations 216 as being interchangeable system inputs 210. The multi-reference model training system 106 thereby trains a model that can handle switching of inputs at inference time without excessively hindering a predictive ability of the multilingual machine translation evaluation model.

At inference time, the multi-reference machine translation evaluation model can embed the original source language input text segment 212, the machine translation (or hypothesis) 214, the reference translation 216 and an alternative reference translation (not shown) via, for example, the embeddings concatenation system 130 (shown in FIG. 3A). The embeddings concatenation system 130 can provide the embeddings to the feed-forward regressor system 140 (shown in FIG. 3A) in one or more of the following permutations: [s; h; r], [r; h; s], [s; h; \hat{r}], [\hat{r}; h; s], [r; h; \hat{r}] and [\hat{r}; h; r], wherein h represents a hypothesis embedding of the machine translation (or hypothesis) 214, s represents a source embedding of the original source language input text segment 212, r represents a reference embedding of the reference translation 216 and \hat{r} represents an alternative reference embedding of the alternative reference translation.

The feed-forward regressor system 140 can receive each respective permutation of the embeddings and provide a prediction based upon the permutation of the embeddings. The resulting score predictions for the various permutations of the embeddings can be the same, or different. The feed-forward regressor system 140, for example, can generate aggregated scores by computing a mean of the predictions and multiplying the mean of the predictions by a scaling factor (l−σ) that is equal to one minus a standard deviation (σ). The scaling factor (l−σ) advantageously can provide a confidence score for the multilingual machine translation evaluation model at the segment-level. Additionally and/or alternatively, scaling the mean prediction by the scaling factor (l−σ) to penalize lower confidence can better align the multilingual machine translation evaluation model with human quality scores.

At inference time, the original source language input text segment 212 and the reference translation 216 can be introduced in varying configurations to the model resulting from selected embodiments of the multi-reference model training system 106. If no reference translation 216 is available, for example, the resulting MT evaluation model can receive the original source language input text segment 212 twice with the second instance of the original source language input text segment 212 being received as the reference translation 216.

If two reference translations 216 are available at inference time, the resulting MT evaluation model alternatively can receive both reference translations 216 with the second instance of the reference translation 216 being received as the original source language input text segment 212.

Corpora

To demonstrate the effectiveness of the evaluation model training system 100, three MT evaluation models were trained, where each model targeted a different type of human scoring of translation quality. To train these multilingual machine translation evaluation models, data from four different corpora was used: the QT21 corpus; the DARR from the WMT Metrics shared task (2017 to 2019); an extension of the latter corpus containing multiple references established by Freitag et al. (2020) (“BLEU might be Guilty but References are not Innocent,” Freitag et al., 2020), and a proprietary MQM annotated corpus.

The QT21 Corpus

The QT21 corpus is a dataset that is available at https://lindat.mff.cuni.cz/repository/xmlui/handle/11372/LRT-2390 and contains industry generated sentences from the information technology and life sciences domains (“Translation Quality and Productivity: A Study on Rich Morphology Languages,” Specia et al., 2017). The QT21 corpus contains a total of 173K tuples with source sentence, respective human-generated reference translation, MT hypothesis (either from a phrase-based statistical MT or from a neural MT system), and a human post-edited correction of the MT hypothesis (PE). The language pairs represented in this corpus are English to German (en-de), English to Latvian (en-lt), English to Czech (en-cs) and German to English (de-en).

For each tuple in the corpus, the HTER score is obtained by computing the translation edit rate (TER) ((“A Study of Translation Edit Rate with Targeted Human Annotation,” Snover et al., 2006) between the MT hypothesis and the corresponding PE. Finally, after computing the HTER for each MT, a training dataset D={sᵢ,hᵢ,rᵢ,yᵢ}ₙ₌₁^{N} was built, wherein sᵢ denotes the source text, hᵢ denotes the MT hypothesis, rᵢ the reference translation, and y, the HTER score for the hypothesis hᵢ. In this manner a regression ƒ(s, h, r)→y is learned that predicts the human-effort required to correct the hypothesis by looking at the source, hypothesis, and reference (but not the post-edited hypothesis).

The WMT DARR Corpus

Since 2017, the organizers of the WMT News Translation Shared Task (“Findings of the 2019 Conference on Machine Translation (WMT19),” Loïc Barrault et al., 2019) have collected human quality scores in the form of adequacy DAs (“Continuous Measurement Scales in Human Evaluation of Machine Translation,” Yvette Graham et al., 2013, “Is Machine Translation Getting Better over Time?”, Yvette Graham et al., 2014, “Can Machine Translation Systems be Evaluated by the Crowd Alone?,” Yvette Graham et al., 2017). The DAs are then mapped into relative rankings (DARR) (“Results of the WMT19 Metrics Shared Task: Segment-level and Strong MT Systems Pose Big Challenges,” Ma et al., 2019a). The resulting data for each year (2017-19) form a dataset D={sᵢ,hᵢ⁺,hᵢ⁻,rᵢ}ₙ₌₁^{N} where denotes a “better” hypothesis and denotes a “worse” one. Here, a function ƒ(s, h, r) is learned such that the score assigned to hᵢ⁺ is, in an embodiment, higher than the score assigned to hᵢ⁻(ƒ(sᵢ, hᵢ⁺, rᵢ)>ƒ(sᵢ, hᵢ⁻, rᵢ)). This data contains a total of twenty-four high and low-resource language pairs such as Chinese to English (zh-en) and English to Gujarati (en-gu).

The Multi-Reference Corpus

The Multi-Reference corpus was established by Freitag et al. (2020) (“BLEU might be Guilty but References are not Innocent,” Freitag et al. 2020) and extends the WMT DARR corpus for English to German and German to English with three additional reference translations: AR reference (an additional high-quality reference translation), ARp reference (a “paraphrased-as-much-as-possible” version of AR), and WMTp reference (a “paraphrased-as-much-as-possible” version of the original WMT reference). For the latter, the evaluation model training system 100 can use the alternative reference given in the WMT19 News shared task test set being part of the WMT DARR corpus defined herein. The corpus also provides human-generated adequacy assessments for each reference.

The MQM Corpus

The MQM corpus is an Unbabel Inc. proprietary internal database of MT-generated translations of customer support chat messages that were annotated according to the guidelines set out in “Practical Guidelines for the Use of MQM in Scientific Research on Translation quality,” by Burchardt and Lommel (2014). This data contains a total of 12K tuples, covering twelve language pairs from English to: German (en-de), Spanish (en-es), Latin-American Spanish (en-es-latam), French (en-fr), Italian (en-it), Japanese (en-ja), Dutch (en-nl), Portuguese (en-pt), Brazilian Portuguese (en-pt-br), Russian (en-ru), Swedish (en-sv), and Turkish (en-tr). Note that in this corpus English is always present as the source language, but never as the target language. Each tuple consists of a source sentence, a human-generated reference, a MT hypothesis, and its MQM score annotated by one (or more) professional editors. The MQM scores range from −∞ co to 100 and are defined as:

$$MQM = 100 - \frac{{I}_{Minor} + 5 \times {I}_{Major} + 10 \times {I}_{Crit}}{Sentence Length \times 100} \qquad ( Equation 11 )$$

where I_{Minor} denotes the number of minor errors, I_{Major} the number of major errors and I_{Crit.} the number of critical errors.

MQM takes into account the severity of the errors identified in the MT hypothesis, leading to a more fine-grained metric than HTER or DA. When used experimentally, these values were divided by 100 and truncated at 0. A training dataset D={sᵢ,hᵢ,rᵢ,yᵢ}ₙ₌₁^{N} was constructed in the manner set forth above with reference to the WMT DARR corpus, where sᵢ denotes the source text, hᵢ denotes the MT hypothesis, rᵢ denotes the reference translation, and yᵢ denotes the MQM score for the hypothesis hᵢ.

### Experiments

For purposes of experimentation, three MT evaluation models trained using alternative embodiments of the evaluation model training system 100 were examined. Two models were trained using the estimator model training system 102 as shown and described with reference to FIG. 3A. One of the models trained using the estimator model training system 102 was trained to regress on HTER (Est-HTER) and was trained on the QT21 corpus, and the other model trained using the estimator model training system 102 was trained to regress on MQM (Est-MQM) and was trained on the internal MQM corpus. For the translation ranking model training system 104 as shown and described with reference to FIG. 3B, a multilingual machine translation evaluation model was trained on the WMT DARR corpus from 2017 and 2018 (Rank-DARR). In the following section, the training setup for these models and corresponding evaluation setup is discussed.

Training Setup

The two models trained using the estimator model training system 102 of FIG. 3A (Est-HTER/MQM) share the same training setup and hyper-parameters. Table 1 below lists the hyper-parameters used to train these three multilingual machine translation evaluation models.

TABLE 1
Hyper-parameters for training the presented models.

| Hyper-parameter | Est-HTER/MQM | Rank-DARR |
|---|---|---|
| Encoder Model | XLM-RoBERTa (base) | XLM-RoBERTa (base) |
| Optimizer | Adam (default | Adam (default |
| | parameters) | parameters) |
| n° frozen epochs | 1 | 0 |
| Learning rate | 3e − 05 and 1e − 05 | 1e − 05 |
| Batch size | 16 | 16 |
| Loss function | MSE | Triplet Margin (ϵ = 1.0) |
| Layer-wise dropout | 0.1 | 0.1 |
| FP precision | 32 | 32 |
| Feed-Forward hidden | 2304, 1152 | — |
| units | | |
| Feed-Forward activations | Tanh | — |
| Feed-Forward dropout | 0.1 | — |

Before initializing the multilingual machine translation evaluation models, a random seed was set to three in all libraries that perform “random” operations (torch, numpy, random and cuda).

For training, the pretrained and/or cross-lingual encoder system 112 (shown in FIG. 3A) was loaded and both the layered pooling system 122 (shown in FIG. 3A) and the feed-forward regressor system 140 (shown in FIG. 3A) were initialized. Whereas layer-wise scalars a for the layered pooling system 122 are initially set to zero, weights for the feed-forward regressor system 140 are initialized randomly. During training, the model parameters were divided into two groups: the encoder parameters, that include the encoder model and the scalars from a, for the pretrained and/or cross-lingual encoder system 112; and regressor parameters, that include the parameters from the top feed-forward network, for the feed-forward regressor system 140. Gradual unfreezing and discriminative learning rates were applied (Howard and Ruder, 2018), meaning that the encoder model is frozen for one epoch; while, the feed-forward regressor system 140 is optimized with, for example, a learning rate of 3e-5. After the first epoch, the entire model is fine-tuned but the learning rate for the encoder parameters is set to, for example, 10⁻⁵, in order to avoid catastrophic forgetting.

To set up the training of the Rank-DARR model using the translation ranking model training system 104 of FIG. 3B, the multilingual machine translation evaluation model was trained by a parameter “fine-tuning” process. Furthermore, since the architecture of training system 104 of FIG. 3B does not add any new parameters on top of XLM-RoBERTa (base) other than the layer scalars a, a single learning rate, in this example 10⁻⁵, was used for the entire model training.

The Rank-DARR multilingual machine translation evaluation model trained using the translation ranking model training system 104 was trained on the WMT DARR corpus in the manner described in more detail above. With a probability of 0.5, the positions of the original source language input text segment 212 and the reference translation 216 at input are switched, allowing the model to better align the multilingual embedding space and to treat the original source language input text segment 212 and the reference translation 216 interchangeably. All model parameters are otherwise as described above with reference to other models.

Evaluation Setup

The test data and setup of the WMT 2019 Metrics Shared Task (“Results of the WMT19 Metrics Shared Task: Segment-level and Strong MT Systems Pose Big Challenges,” Ma et al., 2019) were used to compare the three example multilingual machine translation evaluation models (Est-HTER, Est-MQM and Rank-DARR) trained by the respective embodiments of the evaluation model training system 100, with the top performing submissions of the shared task and other recent state-of-the-art metrics such as BERTScore and BLEURT. The evaluation method used is the official Kendall's Tau-like formulation, τ, from the WMT 2019 Metrics Shared Task (Ma et al., 2019) defined as:

$$τ = \frac{\vert Concordant - Discordant \vert}{\vert Concordant + Discordant \vert} \qquad ( Equation 12 )$$

where Concordant is a number of times a metric assigns a higher score to the “better” hypothesis h⁺, such as the better machine translation 214A (shown in FIG. 3B), and Discordant is a number of times a metric assigns a higher score to the “worse” hypothesis h⁻, such as the worse machine translation 214B (shown in FIG. 3B), or the scores assigned to both hypotheses h⁺, h⁻ are the same.

As mentioned in the findings of “Results of the WMT19 Metrics Shared Task: Segment-level and Strong MT Systems Pose Big Challenges,” Ma et al., 2019, segment-level correlations of all originally submitted metrics were frustratingly low. Furthermore, all submitted metrics exhibited a dramatic lack of ability to correctly rank strong MT systems. To evaluate whether the three multilingual machine translation evaluation models trained by the evaluation model training system 100 better address these issues, the described evaluation setup used in the analysis presented in Ma et al., 2019, was followed, where correlation levels are computed for portions of the DARR data that include only the top 10, 8, 6 and 4 MT systems.

Results

Results for the above-referenced experiments are set forth below.

From English into X

Table 2 shows results for all eight language pairs with English as source. The three example models of embodiments of the invention were contrasted against baseline metrics such as BLEU and chrF, the 2019 task winning metric Yisi-1, as well as the more recent BERTScore.

TABLE 2
Kendall's Tau (τ) correlations on language pairs with English
as source for the WMT19 Metrics DARR corpus.

| Metric | en-cs | en-de | en-fi | en-gu | en-kk | en-lt | en-ru | en-zh |
|---|---|---|---|---|---|---|---|---|
| BLEU | 0.364 | 0.248 | 0.395 | 0.463 | 0.363 | 0.333 | 0.469 | 0.235 |
| chrF | 0.444 | 0.321 | 0.518 | 0.548 | 0.510 | 0.438 | 0.548 | 0.241 |
| YiSi-1 | 0.475 | 0.351 | 0.537 | 0.551 | 0.546 | 0.470 | 0.585 | 0.355 |
| BERTScore | 0.500 | 0.363 | 0.527 | 0.568 | 0.540 | 0.464 | 0.585 | 0.356 |
| (default) | | | | | | | | |
| BERTScore | 0.503 | 0.369 | 0.553 | 0.584 | 0.536 | 0.514 | 0.599 | 0.317 |
| (xmr-base) | | | | | | | | |
| Est-HTER | 0.524 | 0.383 | 0.560 | 0.552 | 0.508 | 0.577 | 0.539 | 0.380 |
| Est-MQM | 0.537 | 0.398 | 0.567 | 0.564 | 0.534 | 0.574 | 0.615 | 0.378 |
| Rank-DARR | 0.603 | 0.427 | 0.664 | 0.611 | 0.693 | 0.665 | 0.580 | 0.449 |

For BERTScore and XLM-RoBERTa (base), the results were reported with the default encoder model for a complete comparison. The values reported for YiSi-1 are taken directly from the shared task paper (Ma et al., 2019).

It was observed that all three multilingual machine translation evaluation models trained by the evaluation model training system 100 outperform all of the other metrics across the board, often by significant margins. The Rank-DARR model trained using training system 104 with the WMT DARR corpus outperformed the two models trained using the estimator model training system 102 (Est-HTER and Est-MQM) in seven out of eight language pairs. Also, even though trained on only 12K annotated segments, the estimator model trained using training system 102 regressed on MQM (Est-MQM) performed roughly on par with the estimator model trained using training system 102 regressed on HTER (Est-HTER) for most language-pairs and outperforms all the other metrics in en-ru.

From X into English

Table 3 shows results for the seven to-English language pairs.

TABLE 3
Kendall's Tau (τ) correlations on language pairs with
English as a target for the WMT19 Metrics DARR corpus.

| Metric | de-en | fi-en | gu-en | kk-en | It-en | ru-en | zh-en |
|---|---|---|---|---|---|---|---|
| BLEU | 0.053 | 0.236 | 0.194 | 0.276 | 0.249 | 0.177 | 0.321 |
| chrF | 0.123 | 0.292 | 0.240 | 0.323 | 0.304 | 0.115 | 0.371 |
| YiSi-1 | 0.164 | 0.347 | 0.312 | 0.440 | 0.376 | 0.217 | 0.426 |
| BERTScore (default) | 0.190 | 0.354 | 0.292 | 0.351 | 0.381 | 0.221 | 0.432 |
| BERTScore | 0.171 | 0.335 | 0.295 | 0.354 | 0.356 | 0.202 | 0.412 |
| (xlmr-base) | | | | | | | |
| BLEURT (base-128) | 0.171 | 0.372 | 0.302 | 0.383 | 0.387 | 0.218 | 0.417 |
| BLEURT (large-512) | 0.174 | 0.374 | 0.313 | 0.372 | 0.388 | 0.220 | 0.436 |
| Est-HTER | 0.185 | 0.333 | 0.274 | 0.297 | 0.364 | 0.163 | 0.391 |
| Est-MQM | 0.207 | 0.343 | 0.282 | 0.339 | 0.368 | 0.187 | 0.422 |
| Rank-DARR | 0.202 | 0.399 | 0.341 | 0.358 | 0.407 | 0.180 | 0.445 |

Results for BERTScore and for BLEURT are reported for two model versions: the base model, which is comparable in size with the XLM-RoBERTa (base) model that was used as the pretrained model for encoding system 110 (shown in FIG. 1) of the evaluation model training system 100, and the large model that is twice the size.

Again, the three models trained using the evaluation model training system 100 are contrasted against baseline metrics such as BLEU and chrF, the 2019 task winning metric Yisi-1, as well as the recently published metrics BERTScore and BLEURT. As in Table 2, translation ranking model training system 104 with the WMT DARR corpus showed strong correlations with human judgments outperforming the recently proposed English-specific BLEURT metric in five out of seven language pairs. Furthermore, again, the estimator model trained using training system 102 regressed on MQM (Est-MQM) showed surprisingly strong results despite the fact that this model was trained with data that did not include English as a target language. Although the encoding system 110 used in the trained models of the evaluation model training system 100 is highly multilingual, this powerful “zero-shot” result is likely due to the inclusion of the original source language input text segment 212 in the models of the evaluation model training system 100.

Language Pairs not Involving English

All three of the evaluation models trained with training system 100 were trained on data involving English (either as a source or as a target). Nevertheless, to demonstrate that the models trained using the evaluation model training system 100 generalize well to other languages, these models were also tested on data from the three WMT 2019 language pairs that do not include English as either the source or target language. Results of these tests are shown in Table 4.

TABLE 4
Kendall's Tau (τ) correlations on language pairs not involving
English or the WMT19 Metrics DARR corpus.

| Metric | de-cs | de-fr | fr-de |
|---|---|---|---|
| BLEU | 0.222 | 0.226 | 0.173 |
| chrF | 0.341 | 0.287 | 0.274 |
| YiSi-1 | 0.376 | 0.349 | 0.310 |
| BERTScore (default) | 0.358 | 0.329 | 0.300 |
| BERTScore (xlmr-base) | 0.386 | 0.336 | 0.309 |
| Est-HTER | 0.358 | 0.397 | 0.315 |
| Est-MQM | 0.386 | 0.367 | 0.296 |
| Rank-DARR | 0.389 | 0.444 | 0.331 |

As can be seen in Table 4, the results are consistent with observations in Tables 2 and 3.

Multi-Reference Experiments

Similar experiments also were performed with the multi-reference model training system 106 (shown in FIG. 4). Table 5 below illustrates performance of the model trained using the multi-reference model training system 106 with each reference, either as a single reference or combined in the manner set forth above with regard to the original reference.

TABLE 5
Performance of the model trained using the multi-
reference model training system 106.

| Reference | Adequacy | τ (1 ref) | τ (2 refs) |
|---|---|---|---|
| WMT | 85.3 | 0.523 | — |
| AR | 86.7 | 0.539 | 0.555 |
| WMTp | 81.8 | 0.470 | 0.520 |
| ARp | 80.8 | 0.476 | 0.537 |

Based upon the above results, a positive correlation can be seen between reference quality and its utility to the predictive model.

Utilizing a second reference improved prediction accuracy only when the adequacy of the second reference was as good or better as that of the first reference. These results show that, for approaches such as that employed in the multi-reference model training system 106, quality is more important than quantity, and that lower quality additional references can hurt rather than help improve the correlations obtained using only one single high-quality reference. These results highlight that a single high-quality reference translation is sufficient in order for the MT evaluation models trained with embodiments of training system 100 to learn accurate quality score predictions.

Robustness to High-Quality MT

The three trained models based on training system 100 were further analyzed with respect to their ability to correctly rank high-quality MT systems. The DARR corpus from the 2019 Shared Task was used for evaluating on the subset of the data from the top performing MT systems for each language pair. This example analysis included language pairs for which data for at least ten different MT systems (i.e. all but kk-en and gu-en) could be retrieved. The analysis of the performance of the models trained using evaluation model training system 100, presented herein, was contrasted against the strong, recently proposed, BERTScore and BLEURT, with BLEU as a baseline. Results are presented in FIG. 4. For language pairs where English is the target, the three models trained using the evaluation model training system 100 were either better or competitive with all other contrasted machine translation evaluation metrics. When English is the source, the metrics of the three models trained using the evaluation model training system 100 generally exceed the performance of all other contrasted machine translation evaluation metrics. Even the model trained using estimator model training system 102 to regress on MQM (Est-MQM), which was trained with only 12K segments, was competitive, highlighting the power of the framework of the evaluation model training system 100.

Importance of the Source

To shed some light on the actual value and contribution of the original source language input text segment 212 to the ability of the evaluation model training system 100 to learn accurate predictions, two versions of the Rank-DARR model using the ranking model training system 104 were trained using the WMT DARR corpus: one of the Rank-DARR models used only the reference translation 216; whereas, the other Rank-DARR model used both reference translation 216 and the original source language input text segment 212. Both models were trained using the WMT 2017 corpus that only includes language pairs from English (en-de, en-cs, en-fi, en-tr). In other words, while English was never observed as a target language during training for either version of the model, the training of the second version included English source embeddings. The two versions of the Rank-DARR model trained using the translation ranking model training system 104 were then tested on the WMT 2018 corpus for these language pairs and for the reversed directions. The test results are shown in Table 6.

TABLE 6
Comparison between Rank-DARR and a reference-only
version thereof on WMT18 data.

| Metric | en-cs | en-de | en-fi | en-tr | cs-en | de-en | fi-en | tr-en |
|---|---|---|---|---|---|---|---|---|
| Rank-DARR | 0.660 | 0.764 | 0.630 | 0.539 | 0.249 | 0.390 | 0.159 | 0.128 |
| (ref. only) | | | | | | | | |
| Rank-DARR | 0.711 | 0.799 | 0.671 | 0.563 | 0.356 | 0.542 | 0.278 | 0.260 |
| Δτ | 0.051 | 0.035 | 0.041 | 0.024 | 0.107 | 0.155 | 0.119 | 0.132 |

The results in Table 6 clearly show that for the translation ranking architecture model training system 104, including the original source language input text segment 212 improves the overall correlation with human quality rankings. Furthermore, the inclusion of the original source language input text segment 212 exposed the second version of the model to English embeddings, which is reflected in a higher Δτ for the language pairs with English as the target language.

External Validation

A recent research paper from Google (“Experts, Errors, and Context: A Large-Scale Study of Human Evaluation for Machine Translation,” Freitag et al. 2021) measured the correlation of scores produced by a variety of automated MT evaluation metrics, including the models formed via the evaluation model training system 100, with a significant corpus of human quality scores in the form of MQM scores. Two experiments, with data from English to German and Chinese to English, concluded that the models herein described showed significantly higher correlation with human quality scores than all other evaluated metrics.

Independently, a recent research paper from Microsoft (“To Ship or Not to Ship: Extensive Evaluation of Automatic Metrics for Machine Translation”, Kocmi et al. 2021) conducted an in-depth investigation of the correlation between the scores generated by multiple MT evaluation metrics, including the models trained using embodiments of model training system 100 described herein, and a significant corpus of human-generated MT system rankings, for a large collection of MT systems developed by Microsoft that cover multiple language-pairs and domains. Results indicated that the MT evaluation models trained using embodiments of training system 100 exhibited significantly higher levels of correlation with the human rankings than all other MT evaluation metrics. The authors further recommended that the models described herein be broadly adopted by the MT community at large as a primary MT evaluation metric.

Data Statistics

Tables 7-12 show key data statistics for the corpora used to train and test the models trained using embodiments of the evaluation model training system 100.

TABLE 7
Statistics for the QT21 corpus.

| | en-de | en-cs | en-lv | de-en |
|---|---|---|---|---|
| Total tuples | 54000 | 42000 | 35474 | 41998 |
| Avg. tokens (reference) | 17.80 | 15.56 | 16.42 | 17.71 |
| Avg. tokens (source) | 16.70 | 17.37 | 18.39 | 17.18 |
| Avg. tokens (MT) | 17.65 | 15.64 | 16.42 | 17.78 |

TABLE 8
Statistics for the WMT 2017 DARR corpus.

| | en-cs | en-de | en-fi | en-lv | en-tr |
|---|---|---|---|---|---|
| Total tuples | 32810 | 6454 | 3270 | 3456 | 247 |
| Avg. tokens (reference) | 19.70 | 22.15 | 15.59 | 21.42 | 17.57 |
| Avg. tokens (source) | 22.37 | 23.41 | 21.73 | 26.08 | 22.51 |
| Avg. tokens (MT) | 19.45 | 22.58 | 16.06 | 22.18 | 17.25 |

TABLE 9
Statistics for the WMT 2019 DARR into-English language pairs.

| | de-en | fi-en | gu-en | kk-en | lt-en | ru-en | zh-en |
|---|---|---|---|---|---|---|---|
| Total tuples | 85365 | 32179 | 20110 | 9728 | 21862 | 39852 | 31070 |
| Avg. tokens (reference) | 20.29 | 18.55 | 17.64 | 20.36 | 26.55 | 21.74 | 42.89 |
| Avg. tokens (source) | 18.44 | 12.49 | 21.92 | 16.32 | 20.32 | 18.00 | 7.57 |
| Avg. tokens (MT) | 20.22 | 17.76 | 17.02 | 19.68 | 25.25 | 21.80 | 39.70 |

TABLE 10
Statistics for the WMT 2019 DARR from-English and no-English language pairs.

| | en-cs | en-de | en-fi | en-gu | en-kk | en-lt | en-ru | en-zh | fr-de | de-cs | de-fr |
|---|---|---|---|---|---|---|---|---|---|---|---|
| Total tuples | 27178 | 99840 | 31820 | 11355 | 18172 | 17401 | 24334 | 18658 | 1369 | 23194 | 4862 |
| Avg. tokens | 22.92 | 25.65 | 20.12 | 33.32 | 18.89 | 21.00 | 24.79 | 9.25 | 22.68 | 22.27 | 27.32 |
| (reference) | | | | | | | | | | | |
| Avg. tokens | 24.98 | 24.97 | 25.23 | 24.32 | 23.78 | 24.46 | 24.45 | 24.39 | 28.60 | 25.22 | 21.36 |
| (source) | | | | | | | | | | | |
| Avg. tokens | 22.60 | 24.98 | 19.69 | 32.97 | 19.92 | 20.97 | 23.37 | 6.83 | 23.36 | 21.89 | 25.68 |
| (MT) | | | | | | | | | | | |

TABLE 11
MQM corpus (section 2.3) statistics.

| | en-nl | en-sv | en-ja | en-de | en-ru | en-es | en-fr | en-it | en-pt-br | en-tr | en-pt | en-es-latam |
|---|---|---|---|---|---|---|---|---|---|---|---|---|
| Total tuples | 2447 | 970 | 1590 | 2756 | 1043 | 259 | 1474 | 812 | 504 | 370 | 91 | 6 |
| Avg. tokens | 14.10 | 14.24 | 20.32 | 13.78 | 13.37 | 10.90 | 13.75 | 13.61 | 12.48 | 7.95 | 12.18 | 10.33 |
| (reference) | | | | | | | | | | | | |
| Avg. tokens (source) | 14.23 | 15.31 | 13.69 | 13.76 | 13.94 | 11.23 | 12.85 | 14.22 | 12.46 | 10.36 | 13.45 | 12.33 |
| Avg. tokens (MT) | 13.66 | 13.91 | 17.84 | 13.41 | 13.19 | 10.88 | 13.59 | 13.02 | 12.19 | 7.99 | 12.21 | 10.17 |

TABLE 12
Statistics for the WMT 2018 DARR language pairs.

| | zh-en | en-zh | cs-en | fi-en | ru-en | tr-en | de-en | en-cs | en-de | en-et | en-fi | en-ru | en-tr | et-en |
|---|---|---|---|---|---|---|---|---|---|---|---|---|---|---|
| Total tuples | 33357 | 28602 | 5110 | 15648 | 10404 | 8525 | 77811 | 5413 | 19711 | 32202 | 9809 | 22181 | 1358 | 56721 |
| Avg. tokens | 28.86 | 24.04 | 21.98 | 21.13 | 24.97 | 23.25 | 23.29 | 19.50 | 23.54 | 18.21 | 16.32 | 21.81 | 20.15 | 23.40 |
| (reference) | | | | | | | | | | | | | | |
| Avg. tokens | 23.86 | 28.27 | 18.67 | 15.03 | 21.37 | 18.80 | 21.95 | 22.67 | 24.82 | 23.47 | 22.82 | 25.24 | 24.37 | 18.15 |
| (source) | | | | | | | | | | | | | | |
| Avg. tokens | 27.45 | 14.94 | 21.79 | 20.46 | 25.25 | 22.80 | 22.64 | 19.73 | 23.74 | 18.37 | 17.15 | 21.86 | 19.61 | 23.52 |
| (MT) | | | | | | | | | | | | | | |

In selected embodiments, one or more of the features disclosed herein can be provided as a computer program product being encoded on one or more non-transitory machine-readable storage media. As used herein, a phrase in the form of at least one of A, B, C and D herein is to be construed as meaning one or more of A, one or more of B, one or more of C and/or one or more of D.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A modular software framework for training multilingual neural machine translation (MT) evaluation models that supports multiple variant architectures suitable for supervised neural training with different optimization objectives on data collections of MT-generated translations annotated with human quality scores, comprising:
an encoder system for transforming text input into token-level embedding representations suitable for encoding an original source language text segment, a machine translation of the original source language text segment and a reference translation of the original source language text segment into their corresponding embedding space representations;
a pooling layer system for pooling and combining the token-level embedding representations into segment-level embedding representations, extracting multiple contrastive feature vector representations from the segment-level embedding representations, combining the vector representations, and generating predicted translation quality scores suitable for optimizing weights of an entire resulting neural system using multiple optimization objectives; and
an inference system for loading a multilingual MT evaluation model that was trained using the framework and using the model to generate a predicted quality score for any new input tuple consisting of a new original source language text segment, a new machine translation of the new original source language text segment and a new reference translation of the new original source language text segment.

2. The modular software framework of claim 1, wherein said inference system is modified to support two reference translations by substituting the original source language text segment with a second reference translation of the original source language text segment.

3. The modular software framework of claim 1, wherein said inference system is modified to support zero reference translations by substituting the reference translation of the original source language text segment with a second copy of the original source language text segment.

4. An estimator-based architecture for training a multilingual machine translation evaluation model, comprising:
an encoder system for transforming text input into token-level embedding representations suitable for encoding an original source language text segment, a machine translation of the original source language text segment and a reference translation of the original source language text segment into their corresponding d-dimensional numeric embedding space representations;
a pooling layer system for pooling and combining the token-level embedding representations into segment-level embedding representations;
an embeddings concatenation system for extracting multiple contrastive feature vector representations from the segment-level embedding representations and combine the vector representations into a single vector representation; and
a neural feed-forward regression system for learning a regression function for generating a machine translation quality score via neural weight optimization.

5. The estimator-based architecture of claim 4, wherein said encoder system is implemented via a pretrained multilingual transformer-based language model.

6. The estimator-based architecture of claim 4, wherein said pooling layer system applies a layer attention mechanism that pools the token-level embedding representations from one or more transformer layers of said encoder system.

7. The estimator-based architecture of claim 4, wherein said embeddings concatenation system is configured for:
extracting an element-wise source product between the embedding representation of the machine translation and the embedding representation of the original source language segment;
extracting an element-wise reference product between the embedding representation of the machine translation and the embedding representation of the reference translation;
extracting an absolute element-wise source difference between the embedding representation of the machine translation and the embedding representation of the original source language segment;
extracting an absolute element-wise reference difference between the embedding representation of the machine translation and the embedding representation of the reference translation; and
concatenating the element-wise source product, the element-wise reference product, the absolute element-wise source difference and the absolute element-wise reference difference with the embedding representation of the reference translation and the embedding representation of the machine translation to form a combined vector.

8. A method for training an estimator-based multilingual machine translation evaluation model by iteratively optimizing weights of the entire neural system, including the encoder system, the layer attention mechanism and/or the feed-forward regression system, via standard neural back-propagation optimization on data collections of MT-generated translations annotated with human quality scores, comprising:
transforming text input into token-level embedding representations, encoding an original source language text segment, a machine translation of the original source language text segment and a reference translation of the original source language text segment into their corresponding d-dimensional numeric embedding space representations;
pooling and combining the token-level embedding representations into segment-level embedding representations;
extracting multiple contrastive feature vector representations from the segment-level embedding representations and combining the vector representations into a single vector representation;
applying a neural feed-forward regression system designed to generate a predicted translation quality score function for each training example; and
iteratively optimizing the weights of the entire neural system, including the encoder system, the layer attention mechanism and/or the feed-forward regression system, via standard neural weight back-propagation optimization for a given loss-function on data collections of MT-generated translations annotated with human quality scores.

9. The method of claim 8, wherein the loss-function comprises a Mean-Squared-Error (MSE) function for optimizing the weights of the entire neural system, including the encoder system, the layer attention mechanism and/or the feed-forward regression system, via the standard neural weight back-propagation optimization on the data collections of the MT-generated translations annotated with the human quality scores.

10. The method of claim 8, wherein the method is adapted for multi-reference inference, and wherein, during training, positions of the original source language text segment and the reference translation of the original source language text segment are swapped with a probability p.

11. A ranking-based architecture for training a multilingual machine translation evaluation model, comprising:
an encoder system for transforming text input into token-level embedding representations suitable for encoding an original source language text segment, a machine translation of the original source language text segment and a reference translation of the original source language text segment into their corresponding d-dimensional numeric embedding space representations;
a pooling layer system for pooling and combining the token-level embedding representations into segment-level embedding representations; and
a triplet-margin-loss system for calculating a triplet margin loss for a training example consisting of the segment-level embedding representations of an original source language text segment, a first “better” machine translation of the original source language text segment, a second “worse” machine translation of the original source language text segment and a reference translation of the original source language text segment.

12. The ranking-based architecture of claim 11, wherein said encoder system is implemented via a pretrained multilingual transformer-based language model.

13. The ranking-based architecture of claim 11, wherein said pooling layer system applies a layer attention mechanism that pools the token-level embedding representations from one or more transformer layers from said encoder system.

14. A method for training a ranking-based multilingual machine translation evaluation model by iteratively optimizing weights of the entire neural system, including the encoder system and/or the layer attention mechanism via standard neural back-propagation triplet-margin-loss optimization on data collections of MT-generated translations annotated with human quality scores, comprising:
transforming text input into token-level embedding representations, encoding an original source language text segment, a machine translation of the original source language text segment and a reference translation of the original source language text segment into their corresponding d-dimensional numeric embedding space representations;
pooling and combining the token-level embedding representations into segment-level embedding representations;
calculating a triplet margin loss for a training example consisting of the segment-level embedding representations of an original source language text segment, a first “better” machine translation of the original source language text segment, a second “worse” machine translation of the original source language text segment and a reference translation of the original source language text segment; and
iteratively optimizing the weights of the entire neural system, including the encoder system and/or the layer attention mechanism via the standard neural weight back-propagation triplet-margin-loss optimization on data collections of MT-generated translations annotated with human quality scores.

15. The method of claim 14, wherein the method is adapted for multi-reference inference, and wherein, during training, positions of the original source language text segment and the reference translation of the original source language text segment are swapped with a probability p.
